(19) United States
(12) Patent Application Publication
(10) Pub. No.: US 2005/0216827 A1
(43) Pub. Date: Sep. 29, 2005

(54) Document management program and document management apparatus

(75) Inventor: Takatoshi Mochizuki, Kobe-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 10/924,915

(22) Filed: Aug. 25, 2004

(30) Foreign Application Priority Data
Mar. 29, 2004 (JP) 2004-096916

(51) Int. Cl. G06F 17/00

(52) U.S. Cl. 715/511; 715/513; 707/203

(57) ABSTRACT

The document management program of the present invention receives information, such as a destination address, a subject, and a body, in order to create an e-mail. When receiving an instruction for transmitting the e-mail, the document management program stores document data of a specified file under a different name, and stores information including the transmission date and time, the destination address, and the subject into the database, in association with the document data. Then, the document data is attached to the e-mail, and this e-mail is transmitted.

### CROSS-REFERENCE TO RELATED APPLICATIONS

This application is based on application No. 2004-96916 filed in Japan, the contents of which are hereby incorporated by reference.

### BACKGROUND OF THE INVENTION

[1] Field of the Invention

The present invention relates to a document management program that manages document data, in particular to a technology for managing versions of document data used for various applications.

[2] Related Art

Late years, it has been a common practice to create documents with a word-processor on a personal computer, and vast quantities of documents are being created on a day-to-day basis. Consequently, a demand is growing for a document management system that manages created documents.

In response to such demand, a technology has been developed, for instance, which stores a document before update in a document management database as the preceding version every time when the document is updated (e.g. Japanese Laid-Open Patent Application No. 2003-167911).

After being printed with a printer, a document created with a word-processor may be distributed at a meeting or transmitted as an attached file of an e-mail. Under such circumstances, for example, when the distributed document has been lost by unintentional deletion of an e-mail to which the document is attached, it is sometimes the case that the same document is needed to be acquired.

However, conventional document management systems have a problem in which an acquisition of a needed document is difficult if the version of the lost document is not known. There, the user often does not have a clue which version of the document to acquire, or ends up with getting a wrong version of the document.

### SUMMARY OF THE INVENTION

In view of the above-described problem, the present invention aims to provide a document management program and a document management apparatus which allow for an easy reacquisition of a needed document.

The computer program product for document management according to the present invention comprises the steps of: (a) receiving a specification of document data; (b) receiving a processing instruction for the specified document data; (c) making a copy of the specified document data and storing the copy; and (d) storing tag information, which corresponds to the processing instruction, in association with the copy. It is desirable if the computer program product further comprises the steps of: (e) receiving search data for searching for the stored copy; and (f) retrieving the stored copy which has been associated with the tag information corresponding to the search data.

Conventional document management systems have been designed to store the update history mainly in view of the convenience of document creation. On the other hand, the document management system of the present invention is designed to store the history in the light of document usage, which leads to an easier reacquisition of a document processed at a given time in previous usage. Note that, in the first storing step, the copy of the specified document data may be stored under a different file name, or the copy may retain the original file name while the specified document data is given a different file name. In addition, the tag information will be used later on, for example, in order to search and refer to document data at the time of the processing completed according to the processing instruction.

The computer program product of the present invention may further comprise the step of (g) acquiring information from the received processing instruction, and here the step (d) stores the acquired information as the tag information. This saves the user trouble when the tag information is created. As a result, the convenience of the document management program will be enhanced.

The computer program product of the present invention may further comprise the step of (h) receiving additional information from the user, and here the step (d) stores the additional information along with the acquired information as the tag information. By implementing this step, the document management program is able to receive information to be stored as the tag information from the user. For example, when there are one or more particular matters that the user wants to store or when there is useful information for future search and reference, the user is able to add these to the tag information, and thus this step has a beneficial effect.

The computer program product of the present invention may further comprise the step of (i) receiving a prohibitive instruction and prohibiting the steps (c) and (d) to be executed. With this step, document data that is not required for future search or reference is not stored. As a result, the storage amount used to store document data can be reduced.

In the computer program product of the present invention, the processing instruction may be an instruction for transmitting the specified document data as an attachment to the e-mail. Here, the step (d) stores the destination address, the transmission date and time, the subject, and the body of the e-mail as the tag information. This is beneficial when the user later on wants to reuse the document data which has been transmitted as an e-mail attachment, particularly when the user wants to refer to the contents of the original document data after that contents has been changed with some modification and such.

In the computer program product of the present invention, the processing instruction may be an instruction for transmitting the specified document data according to an FTP. Here, the step (d) stores the server address of the FTP, the transmission date and time, and the folder name of a destination as the tag information. This is beneficial when the user later on wants to reuse the document data which has been transmitted according to the FTP, particularly when the user wants to refer to the contents of the original document data after that contents has been changed.

In the computer program product of the present invention, the processing instruction may be an instruction for printing the specified document data. Here, the step (d) stores the name of the printer used and the printing date and time as the tag information. This is beneficial when the user wants to refer to the contents of the original document data, where the original document data was printed out once and a change has been made to the contents since the printing job.

In the computer program product of the present invention, the processing instruction may be an instruction for processing the specified document data with a specified application program. Here, the step (d) stores the name of the application program and the processing date and time as the tag information. This is beneficial when the user wants to refer to the contents of the original document data which has been processed with an application program.

The document management apparatus of the present invention comprises: a 1st receiving unit operable to receive a specification of document data; a 2nd receiving unit operable to receive a processing instruction for the specified document data; a 1st storing unit operable to make a copy of the specified document data and to store the copy; and a 2nd storing unit operable to store tag information, which corresponds to the processing instruction, in association with the copy. A document management apparatus like this also achieves the purpose of the present invention.

As described hereto, the present invention manages version control of document data based on the usage history. On the other hand, version control of document data has conventionally been managed based on the update history. Owing to this, users of conventional document management systems are often not able to see what kind of output processing has been performed on a given document in the past. In addition, when there is more than one version of the document, each version usually has to be labeled with a different file name. In such a case, it is common that users are not able to access to the document processed at a given time in the past, not knowing which version of the document was outputted at the time.

Consequently, when needing to output the same version of the document once again, users may mistakenly output a version of the document different from the one outputted previously, or have to take a lot of trouble searching the right version.

Suppose that there are three related, already issued conference minutes, and these minutes have been labeled with file names, each of which includes a common part as well as a unique, identifiable part. With a conventional document management system, in order to output all these three as related documents, the user has to search each of the minutes individually using the common part of the file names.

On the other hand, in the present invention, these three minutes are managed as versions of the same document data under the same file name, such as ‘Conference Minute.’ As a result, in order to output the three conference minutes all at once, the user only has to ‘drag and drop’ the document data, and then the document management system automatically accesses and outputs respective versions of the conference minutes, which is exceedingly convenient.

### BRIEF DESCRIPTION OF THE DRAWINGS

These and other objects, advantages and features of the invention will become apparent from the following description thereof taken in conjunction with the accompanying drawings those illustrate a specific embodiments of the invention.

In the drawings:

FIG. 1 is a block diagram showing a configuration of the document management system according to an embodiment of the present invention;

FIG. 2 is a block diagram illustrating the major configuration of the hardware of the user terminal 10 according to the embodiment;

FIG. 3 is a block diagram illustrating the major configuration of the software of the user terminal 10 according to the embodiment;

FIG. 4 is a flowchart showing the transmission process which is executed by the document management program 120 according to the embodiment;

FIG. 5 shows a display window displayed by the document management program 120 according to the embodiment;

FIG. 6 is a flowchart showing the mailer-transmission process which is executed by the document management program 120 according to the embodiment;

FIG. 7 illustrates contents of a database in which the comments are stored in association with the document data by the document management program 120 according to the embodiment;

FIG. 8 shows updated contents of the database in which the comments are stored in association with the document data by the document management program 120 according to the embodiment;

FIG. 9 is a flowchart showing the FTP-transmission process which is executed by the document management program 120 according to the embodiment;

FIG. 10 is a flowchart showing the printer-transmission process which is executed by the document management program 120 according to the embodiment;

FIG. 11 is a flowchart showing the application-transmission process which is executed by the document management program 120 according to the embodiment;

FIG. 12 is a flowchart showing the mailer-transmission process according to the modification (1) of the present invention; and

FIG. 13 is a flowchart showing the mailer-transmission process according to the modification (2) of the present invention.

### DESCRIPTION OF PREFERRED ENBODIMENTS

In reference to the figures, a document management system is explained below by way of example to illustrate an embodiment of the document management program according to the present invention.

[1] Configuration of Document Management System

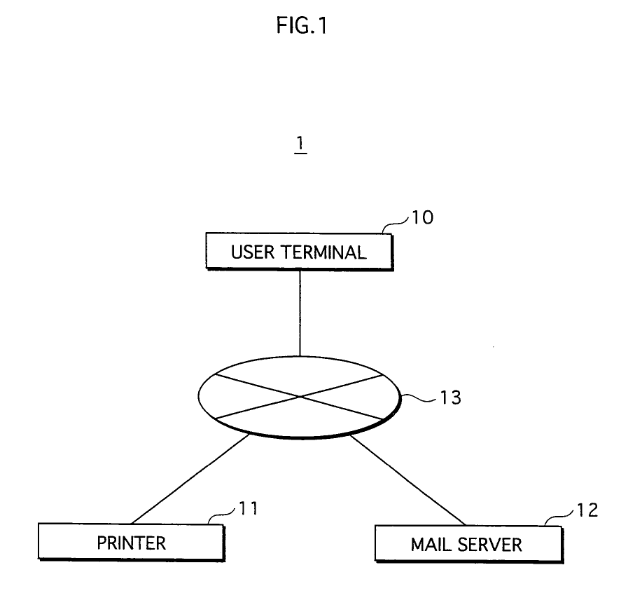

FIG. 1 is a block diagram showing a configuration of the document management system according to the embodiment of the present invention. As shown in FIG. 1, the document management system 1 has a configuration in which a user terminal 10, a printer 11, and a mail server 12 are connected by a communication network 13.

The user terminal 10 is installed with a document management program. Via the communication network 13, the user terminal 10 transmits a request for a printing job to the printer 11 and sends an e-mail to the mail server 12. In this embodiment, the user terminal is a personal computer.

The printer 11 executes a printing job by receiving a printing request from the user terminal 10 via the communication network 13. The printer 11 may for instance be an MFP (Multi Functional Peripheral).

When having received an e-mail from the user terminal 10 via the communication network 13, the mail server 12 transfers the e-mail to the destination terminal. In addition, the mail server 12 transfers an e-mail received from another terminal via the communication network 13 as requested from the user terminal 10.

[2] Configuration of User Terminal 10

The following provides explanation on the configuration of the user terminal 10, separately for the hardware configuration and the software configuration.

[2-1] Hardware Configuration

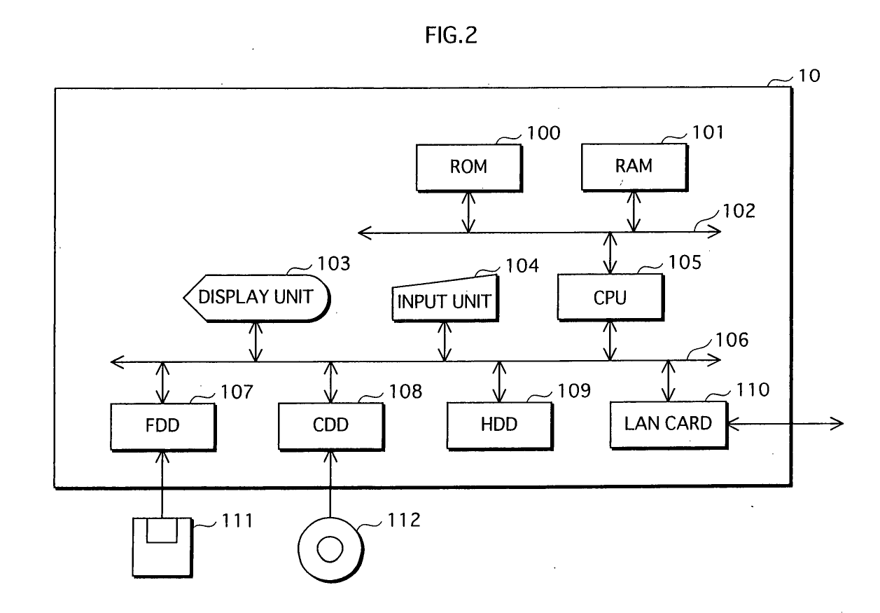

FIG. 2 is a block diagram illustrating the major configuration of the hardware of the user terminal 10. As shown in FIG. 2, the user terminal 10 comprises: a ROM (Read Only Memory) 100, a RAM (Random Access Memory) 101, a display unit 103, an input unit 104, a CPU (Central Processing Unit) 105, an FDD (Flexible Disk Drive) 107, a CDD (CD-ROM Drive) 108, an HDD (Hard Disk Drive) 109, and a LAN (Local Area Network) card 110. The ROM 100, the RAM 101, and the CPU 105 are connected via a memory bus 102. The display unit 103, the input unit 104, the CPU 105, the FDD 107, the CDD 108, the HDD 109, and the LAN card 110 are connected via an internal bus 106.

The ROM 100 is a nonvolatile memory, and stores programs including a boot program of the user terminal 10. The RAM 101 is a volatile memory, and is primarily used as a working storage area. The CPU 105 drives the peripheral equipments including the display unit 103, as well as carries out processing using data stored in the ROM 100 and RAM 101.

The display unit 103 and the input unit 104 are both interface devices, with the display unit 103 for displaying the processing results and the input unit 104 for receiving an input from the user of the user terminal 10.

The FDD 107 is an external memory device for writing and reading data onto/from a flexible disk 111. The CDD 108 is another external memory device which reads data from a CD-ROM 112. The HDD 109 is mass hard disk storage apparatus. In the embodiment of the present invention, document data is stored mainly in the HDD 109.

The LAN card 110 is an interface device that enables the user terminal 10 to communicate with the printer 11 and the mail server 12 via LAN, to which the user terminal 10 is connected.

[2-2] Software Configuration

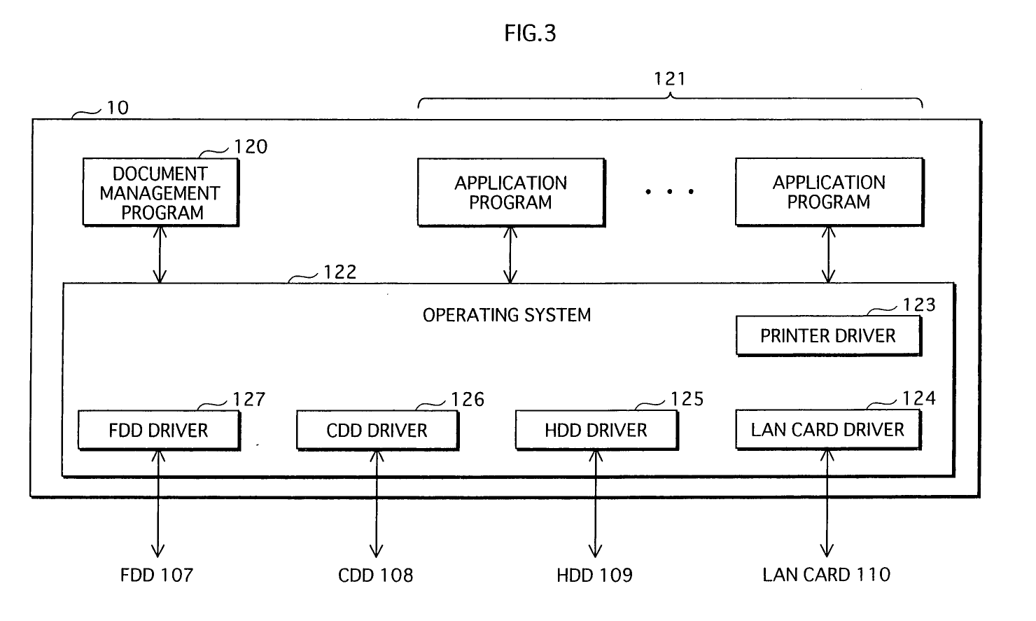

FIG. 3 is a block diagram illustrating major configuration of the software of the user terminal 10. As shown in FIG. 3, the user terminal 10 comprises: a document management program 120, application programs 121, and an Operating System (hereafter, referred to simply as OS) 122. In addition, the followings are built into the OS 122: a printer driver 123, a LAN card driver 124, an HDD driver 125, a CDD driver 126, and an FDD driver 127.

The document management program 120 is an application program that manages documents stored in the user terminal 10. The document management program 120 displays a menu and executes a process selected by the user. Processes to be selected by the user include: a document-data registration process, a tag-information setting process, a search process, a transmission process, and a termination process of the document management program 120.

The document-data registration process is a process of receiving document data from a device, such as a digital camera, a flatbed scanner, a film scanner, or an MFP, and registering and storing the document data. The tag-information setting process is a process of adding search a keyword and marker to the document data that has been already registered. The search process is a process of receiving a specification of a keyword or marker, and searching document data to which the keyword or marker is appended. The transmission process will hereinafter be described.

The application program 121 processes documents on receiving a request from the document management program 120. The OS 122 is a program which manages the hardware resources of the user terminal 10 and controls execution of the document management program 120 and the application programs 121.

The printer driver 123 is a driver which requests printing a document out to the printer 11 and acquires the printer 11 status. The LAN card driver 124 is a driver which transmits and receives data using the LAN card 110.

The HDD driver 125 is a driver which writes and reads document data onto/from the HDD 109. The CDD driver 126 is a driver which reads document data from the CD-ROM 112 using the CDD 108. The FDD driver 127 is a driver which writes and reads document data onto/from the flexible disk 111 using FDD 107.

[3] Operations of Document Management Program 120

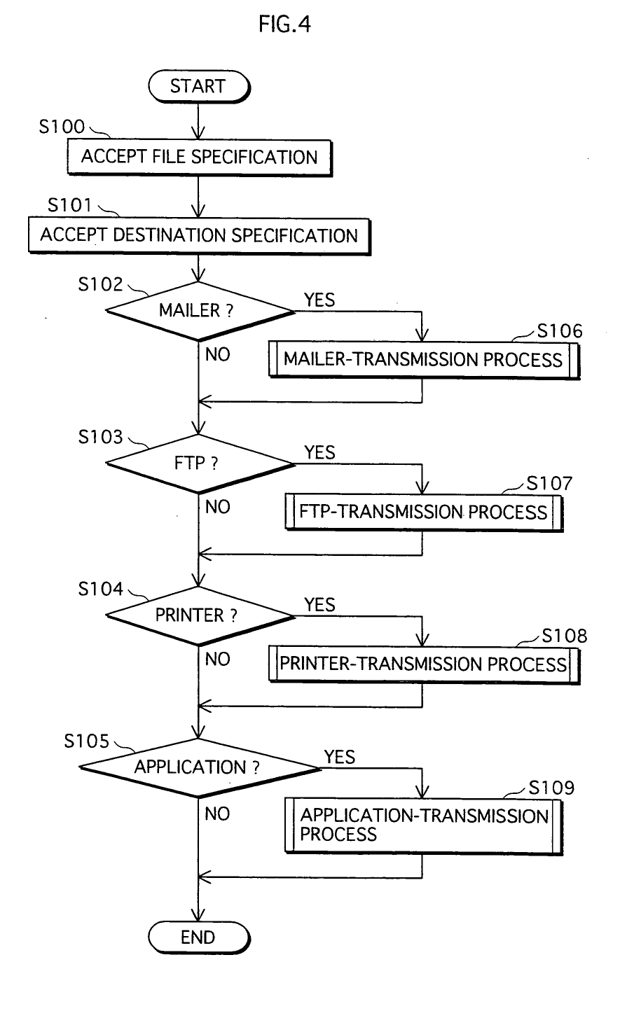

The following gives an account for operations of the document management program 120, in particular for the above-mentioned transmission process. FIG. 4 is a flowchart showing the transmission process which is executed by the document management program 120. As illustrated in FIG. 4, in the transmission process, the document management program 120 first receives a specification of a file to be transmitted as well as a specification of the destination (steps S100 and S101).

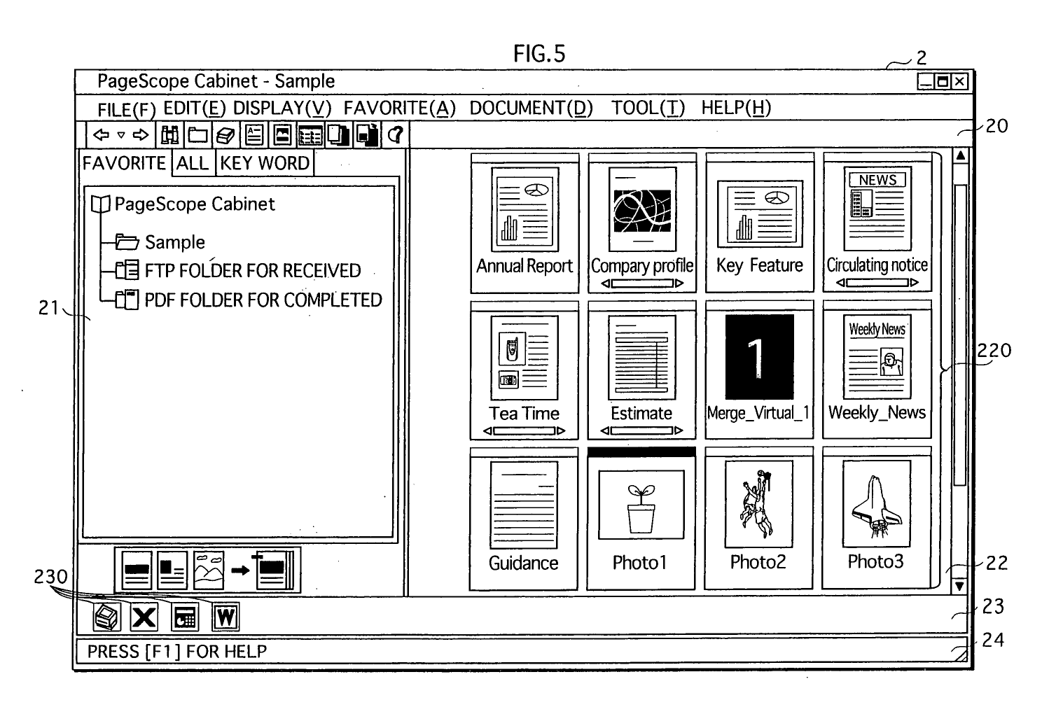

FIG. 5 shows a display window displayed by the document management program 120. As shown in FIG. 5, a toolbar 20, an explorer bar 21, a main window 22, a launcher area 23, and a status bar 24 are displayed on a window 2. In the launcher area 23, icons 230 corresponding to respective application programs are displayed. When the user selects and drags one of the icons 220 appearing on the main window, each of which corresponds to a particular document-data file, and drops this selected file icon 220 onto an icon 230 for an application program 23, the document data is processed with the application program.

Namely, both a file and the sending destination are simultaneously specified by means of ‘drag-and-drop’ of the file icon onto the icon for the application program.

In the present embodiment of the invention, a mailer program, an FTP (File Transfer Protocol, RFC959) client program, and other programs will be dealt with as application programs whose icons 230 are displayed in the launcher area 23. In addition, an icon for the printer driver, which is not an application program, is also displayed in the launcher area.

When the destination is specified as the mailer (step S102: YES), the document management program 120 executes a mailer-transmission process (step S106). If the specification of the destination is not the mailer (step S102: NO) but the FTP client (step S103: YES), then an FTP-transmission process is executed (step S107). If the specification of the destination is not the FTP (step S103: NO) but the printer (step S104: YES), then a printer-transmission process is executed (step S108). If the specification of the destination is not the printer (step S104: NO) but the other application program (step S105: YES), then an application-transmission process is executed (step S109). The above four transmission processes (i.e. the mailer-, the FTP-, the printer-, and the application-transmission processes) will all be described hereinafter. If the specification of destination is not one of the other application programs (step S105: NO), or when the application-transmission process has been completed, the document management program 120 terminates the transmission process.

[3-1] Mailer-Transmission Process (S106)

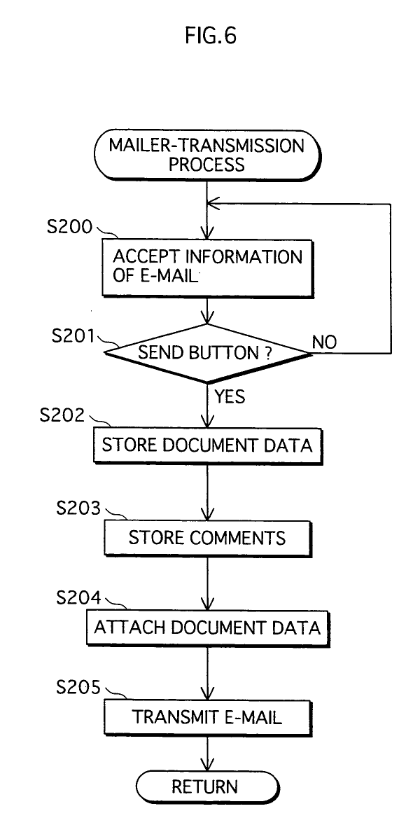

Next, the mailer-transmission process (S106) will be explained further in detail. FIG. 6 is a flowchart showing the mailer-transmission process which is executed by the document management program 120. As illustrated in FIG. 6, the document management program 120 first displays a dialog box for e-mail transmission and receives an input of information for creating an e-mail (step S200). The information for creating an e-mail here includes a destination address, a subject in the subject field, and a body of the e-mail to be transmitted. As long as the ‘Send’ button on the dialog box for e-mail transmission is not clicked (step S201: NO), this process is carried on.

When the ‘Send’ button is clicked (step S201: YES), document data of the specified file is stored (step S202). Then, the document management program 120 stores information into the database as comments in association with the document data (step S203). The information includes the date and time when the ‘Send’ button was clicked, the destination address (such as a To field), and the subject.

Subsequently, the document management program 120 attaches the document data to the e-mail according to the MIME (Multipurpose Internet Mail Extensions, RFC2045, RFC2046 and RFC2047) expansion standard (step S204). After transmitting the e-mail (step S205), the document management program 120 returns to its main routine. Thus, a history indicating that the document was transmitted as an e-mail attachment is stored.

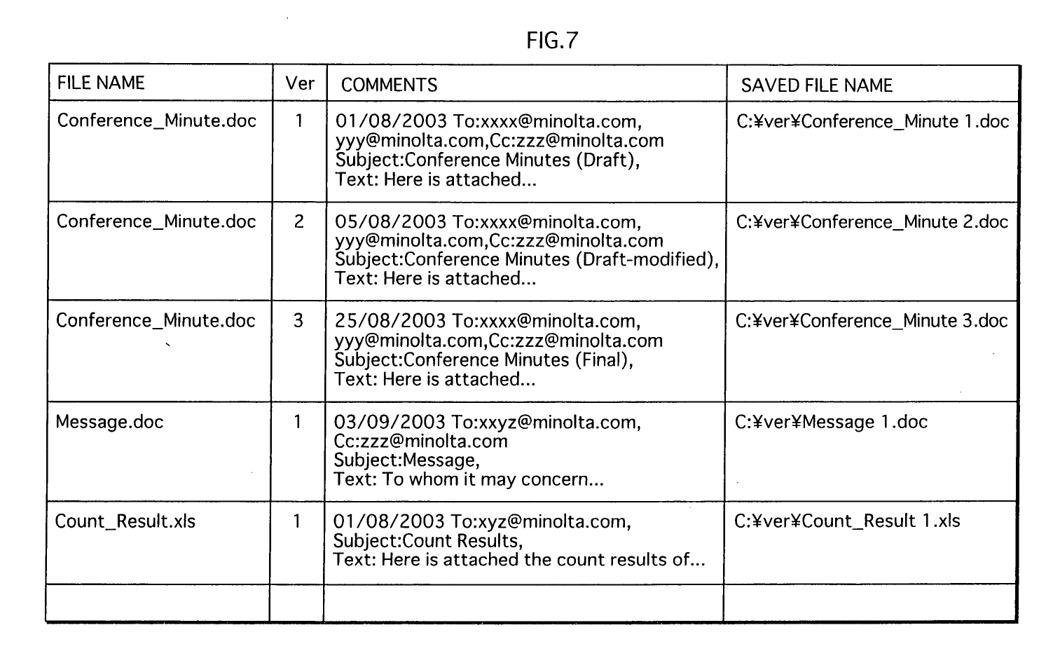

FIG. 7 illustrates contents of a database in which the comments are stored in association with the document data. As shown in FIG. 7, the database according to the present embodiment is a tabular database, and is composed of a file-name field, a version field ‘Ver’, a comment field, and a saved-file-name field. In the file-name field, file names of document data that are managed by the document management program are stored. In the version field, a version number is stored which will be updated every time when the file is transmitted.

In the comment field, the comment is stored which has been created by the document management program 120 at the time when the document-data file is transmitted. In the embodiment of the present invention, the followings are stored as the comments as shown in FIG. 7: a date and time of the e-mail transmission, a description in each header field of To, Cc, and Subject, and the e-mail body.

In the saved-file-name field, the whereabouts of the document data stored at the time of the e-mail transmission and the file name are stored. In the embodiment of the present invention, the saved file name is created by adding the version number to the file name stored in the file-name field.

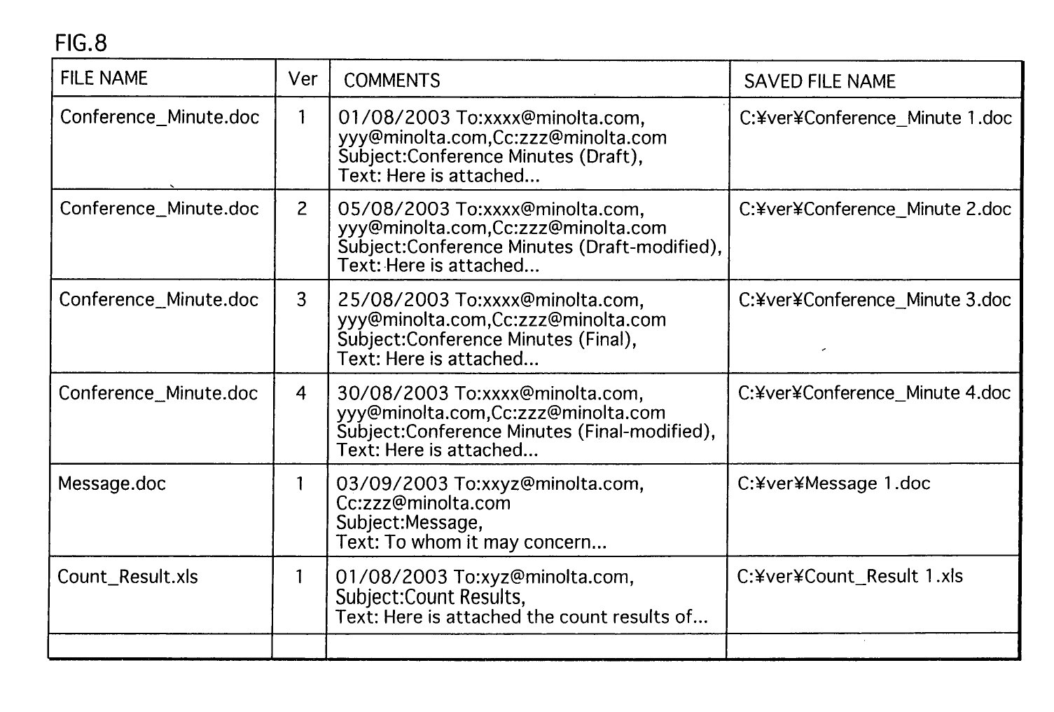

FIG. 8 shows contents of the database after the document data ‘Conference_Minute.doc’ shown in FIG. 7 has been transmitted via e-mail. As to the document data ‘Conference_Minute.doc,’ the record of the version number ‘4’ has been added immediately below the record of the version number ‘3’ of the same document data as shown in FIG. 8.

[3-2] FTP-Transmission Process (S107)

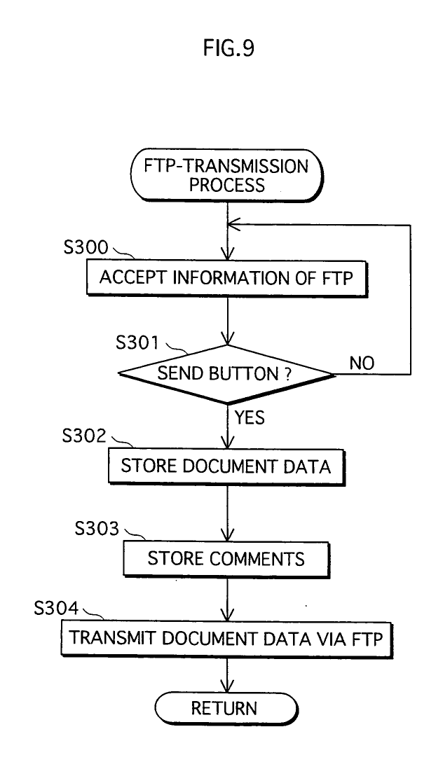

The following will explain the FTP-transmission process (S107). FIG. 9 is a flowchart showing the FTP-transmission process which is executed by the document management program 120. As shown in FIG. 9, the document management program 120 first displays a dialog box for FTP-transmission and receives a destination address, a folder name of the destination, a user name, and a password (step S300). As long as the ‘Send’ button on the dialog box for the FTP-transmission is not clicked (step S301: NO), this process is carried on.

When the ‘Send’ button is clicked (step S301: YES), the document data of the specified file is stored (step S302). Then, the document management program 120 stores information in the database as comments in association with the document data (step S303). The information includes the date and time when the ‘Send’ button was clicked, the destination address, and the folder name of the destination.

After transmitting the document data via FTP (step S304), the document management program 120 returns to its main routine. Thus, a history indicating that the document was transmitted via FTP is stored.

[3-3] Printer-Transmission Process (S108)

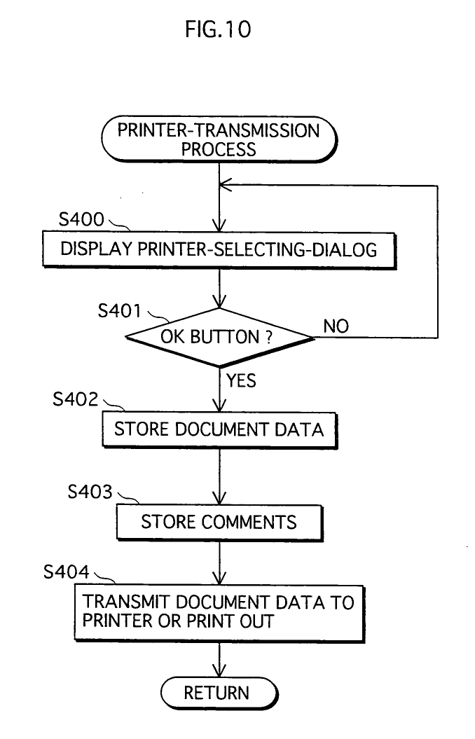

The following provides explanation on the printer-transmission process (S108). FIG. 10 is a flowchart showing the printer-transmission process which is executed by the document management program 120. As shown in FIG. 10, the document management program 120 first displays a dialog box for selecting a printer and receives a selection of a printer to which the document is outputted (step S400). As long as the ‘OK’ button in the dialog box for selecting a printer is not clicked (step S401: NO), this process is carried on.

When the ‘OK’ button is clicked (step S401: YES), the document data of the specified file is stored (step S402). Then, the document management program 120 stores information in the database as comments in association with the document data (step S403). The information is the date and time when the ‘OK’ button was clicked.

After transmitting a request for printing the document data to the selected printer (step S404), the document management program 120 returns to its main routine. Thus, a history indicating that the document was transmitted to the printer is stored.

[3-4] Application-Transmission Process (S109)

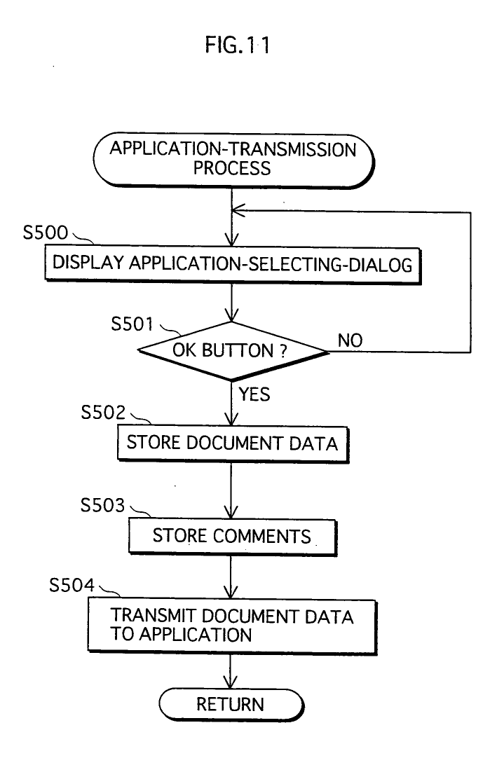

The following will explain the application-transmission process (S109). FIG. 11 is a flowchart showing the application-transmission process which is executed by the document management program 120. As shown in FIG. 11, the document management program 120 first displays a dialog box for selecting an application and receives a selection of an application used to output the document data (step S500). At this point, a list of optional applications is displayed in the selection dialog box, and the application selection is accomplished by clicking on one of the application name appearing in the list. In addition, an ‘OK’ button is displayed in the dialog box for selecting an application, and the process is carried on as long as the ‘OK’ button is not clicked (step S501: NO).

When the ‘OK’ button is clicked (step S501: YES), the document data of the specified file is stored (step S502). Then, the document management program 120 stores information in the database as comments in association with the document data (step S503). The information includes the date and time when the ‘OK’ button was clicked and the name of the selected application.

After transmitting the document data to the selected application (step S504), the document management program 120 returns to its main routine. Thus, a history indicating that the document was transmitted to the application is stored.

[4] Modifications

Although the embodiment of the present invention has been described, it is apparent that the present invention is not confined to the above-mentioned embodiment, and the following modifications can be conducted.

(1) The above embodiment has been described by assuming that version control of document data is unconditionally managed in any transmission process. However, it is apparent that the present invention is not confined to this, and the user may be asked whether or not version control of the document data needs to be managed instead.

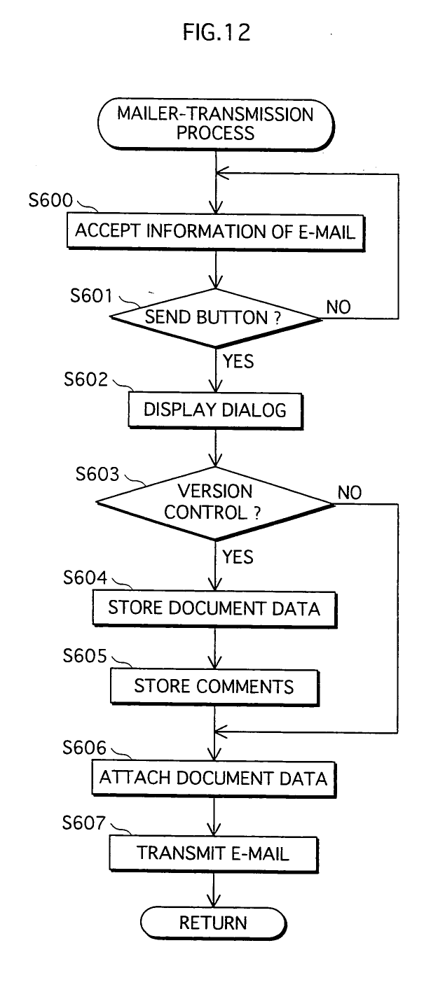

The mailer-transmission process (step S106) is taken as an example to explain the first modification of the present invention. FIG. 12 is a flowchart showing the mailer-transmission process according to this first modification. As shown in FIG. 12, the document management program 120 receives an input of information for creating an e-mail (step S600), like the case described above.

When the ‘Send’ button on the dialog box for e-mail transmission is clicked (step S601: YES), the document management program 120 displays a dialog box for receiving a selection, whether the document data of the mailer transmission should be put under version control (step S602). When an input for implementing version control is received in the dialog box (step S603: YES), the document management program 120 stores the document data and comments (steps S604 and S605), attaches the document data to the e-mail (step S606), and transmits this e-mail (step S607).

When an input for not implementing version control is received (step S603: NO), the document management program 120 attaches the document to the e-mail and transmits this without storing the document data and comments (steps S606 and S607).

In processes other than the mailer-transmission, for example, in the FTP-transmission process (step S107) and the printer-transmission process (step S108), employing operational steps as described above also allows the user to indicate the need of version control. The document data and comments are not stored when the user considers that the version control is unnecessary for the document data, which results in saving storage space of HDD 109 and so forth in the user terminal 10.

(2) The above embodiment has described a case in which the document management program 120 automatically creates comments to be stored in the database in association with the document data. However, it is apparent that the present invention is not confined to this, and instead the comments may be created if the user desires.

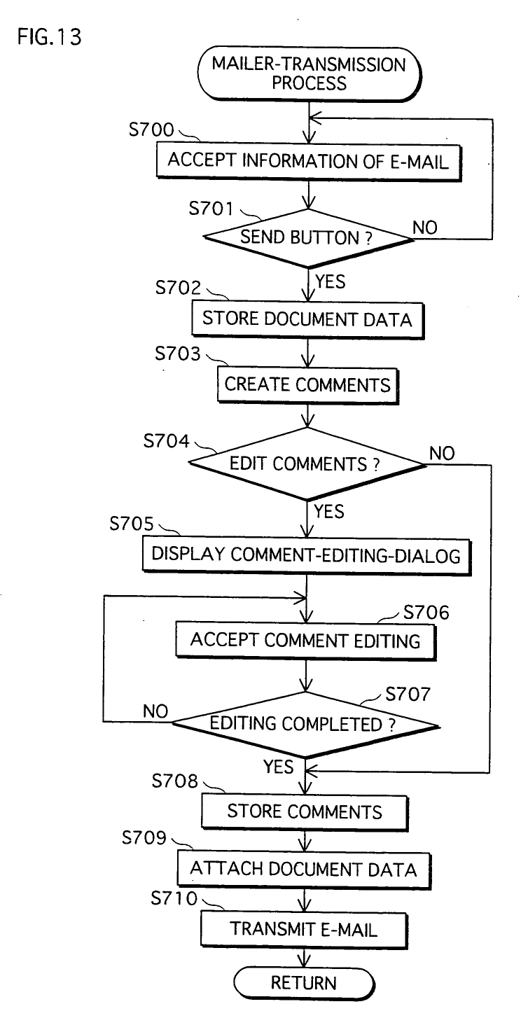

The mailer-transmission process (step S106) is taken as an example to explain the second modification of the present invention. FIG. 13 is a flowchart showing the mailer-transmission process according to this second modification. As shown in FIG. 13, the document management program 120 receives information for creating an e-mail (step S700). Then, when the ‘Send’ button on the dialog box for e-mail transmission is clicked (step S701), the document management program 120 stores the document data (step S702) and creates the comments in the manner described in the above embodiment (step S703).

When a button for editing comments is clicked (step S704: YES), the document management program 120 displays a comment-editing dialog box (step S705) and then allows the user to edit comments in the dialog box (step S706). This enables the user to modify the comments or add new ones if desired.

When the ‘Completed’ button appearing on the comment-editing dialog box is clicked (step S707: YES) or when step S704 is NO, the document management program 120 stores the comments into the database (step S708), attaches the document data to the e-mail (step S709), and transmits this e-mail (step S710).

In processes other than the mailer-transmission process, for example, in the FTP-transmission process (step S107) and the printer-transmission process (step S108), employing operational steps as described above also allows the user to edit the comments if desired.

(3) In the above embodiment, the mailer-, the FTP-, the printer-, and the application-transmission processes were dealt with as transmission processes for the document data. However, it is apparent that the present invention is not limited to these, and version control may be implemented in other transmission processes. For instance, version control can be also implemented when document data is written on a flexible disk 111 using the FDD 107. Apart from this, version control may also be introduced when document data is written on a rewritable record media, such as a CD-RW (Compact Disk ReWritable).

(4) In the above embodiment, it is assumed that version control is implemented when the document management program 120 transmits document data as an e-mail attachment or transmits document data to another application program. It is, however, apparent that the present invention is not confined to these cases. For example, the document management program 120 may receive notification at the time when another application program processes the document data and implement version control.

(5) Although the present invention was described exclusively as a document management program, it is apparent that the present invention is not confined to this. The present invention may be a document management apparatus which manages documents using such a document management program. Furthermore, the present invention may be a method in which such a document management program makes a computer perform document management. Note, in all the cases above, the effect of the present invention is the same.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

1. A computer program product for document management, comprising the steps of:
(a) receiving a specification of document data;
(b) receiving a processing instruction for the specified document data;
(c) making a copy of the specified document data and storing the copy; and
(d) storing tag information, which corresponds to the processing instruction, in association with the copy.

2. The computer program product of claim 1, further comprising the steps of:
(e) receiving search data for searching for the stored copy; and
(f) retrieving the stored copy which has been associated with the tag information corresponding to the search data.

3. The computer program product of claim 1, further comprising the step of:
(g) acquiring information from the received processing instruction, wherein
the step (d) stores the acquired information as the tag information.

4. The computer program product of claim 3, further comprising the step of:
(h) receiving additional information from a user, wherein
the step (d) stores the additional information along with the acquired information as the tag information.

5. The computer program product of claim 1, further comprising the step of:
(i) receiving a prohibitive instruction and prohibiting the steps (c) and (d) to be executed.

6. The computer program product of claim 1, wherein
the processing instruction is an instruction for transmitting the specified document data as an attachment to an e-mail, and
the step (d) stores a destination address, a transmission date and time, a subject, and a body of the e-mail as the tag information.

7. The computer program product of claim 1, wherein
the processing instruction is an instruction for transmitting the specified document data according to an FTP, and
the step (d) stores a server address of the FTP, a transmission date and time, and a folder name of a destination as the tag information.

8. The computer program product of claim 1, wherein
the processing instruction is an instruction for printing the specified document data, and
the step (d) stores a name of a printer used and a printing date and time as the tag information.

9. The computer program product of claim 1, wherein
the processing instruction is an instruction for processing the specified document data with a specified application program, and
the step (d) stores a name of the application program and a processing date and time as the tag information.

10. A document management apparatus comprising:
a 1st receiving unit operable to receive a specification of document data;
a 2nd receiving unit operable to receive a processing instruction for the specified document data;
a 1st storing unit operable to make a copy of the specified document data and to store the copy; and
a 2nd storing unit operable to store tag information, which corresponds to the processing instruction, in association with the copy.

11. The document management apparatus of claim 10, further comprising:
a 3rd receiving unit operable to receive search data for searching for the stored copy; and
a retrieving unit operable to retrieve the stored copy which has been associated with the tag information corresponding to the search data.
